(19) United States
(12) Patent Application Publication
(10) Pub. No.: US 2026/0277603 A1
(43) Pub. Date: Sep. 17, 2026

(54) METHOD, APPARATUS, DEVICE, AND MEDIUM FOR MANAGING CODE DATA

(71) Applicants: Beijing Zitiao Network Technology Co., Ltd., Beijing (CN); Lemon Inc., Grand Cayman (KY)

(72) Inventors: Hongwei Yue, Beijing (CN); Long XIAO, Singapore (SG); Dong HUANG, Beijing (CN)

(21) Appl. No.: 19/562,482

(22) Filed: Mar. 10, 2026

(30) Foreign Application Priority Data
Mar. 11, 2025 (WO) PCT/CN2025/081949

(51) Int. Cl. G06F 8/73

(52) U.S. Cl. CPC G06F 8/73

(57) ABSTRACT

A method, an apparatus, a device, and a medium for managing code data are provided. In the method, an application programming interface associated with a merge request is determined in response to receiving the merge request for merging first code data into second code data. An interface definition of the application programming interface is obtained, and the interface definition describes at least one data item specified in the application programming interface. Annotation data associated with the at least one data item is added to the interface definition, and the annotation data describes the at least one data item in accordance with a code specification of a code management platform. The second code data is committed to the code management platform based on the interface definition.

### CROSS REFERENCE

The present application claims priority to Internation Patent Application PCT/CN2025/081949, filed on Mar. 11, 2025 and entitled “METHOD, APPARATUS, DEVICE, AND MEDIUM FOR MANAGING CODE DATA”, the entirety of which is incorporated herein by reference.

### FIELD

Implementations of the present disclosure generally relate to software development, and more particularly to a method, an apparatus, a device, and a computer-readable storage medium for managing code data.

### BACKGROUND

In an example, during application development, developers may constantly complete the functions of an application. The developers may commit code data of the application to a unified code management platform to check whether the code data conforms to a predetermined code specification. To facilitate the management of code data, the code management platform calls for interpreting the meaning of respective data items in the code data according to the code specification specified by the platform. This leads to a large number of manual operations, especially during the development of an application, which may involve multiple versions, at which time respective data items of code data in different versions need to be manually processed.

### SUMMARY

In a first aspect of the present disclosure, a method for managing code data is provided. In the method, an application programming interface associated with a merge request is determined in response to receiving the merge request for merging first code data into second code data. An interface definition of the application programming interface is obtained, and the interface definition describes at least one data item specified in the application programming interface. Annotation data associated with the at least one data item is added to the interface definition, and the annotation data describes the at least one data item in accordance with a code specification of a code management platform. The second code data is committed to the code management platform based on the interface definition.

In a second aspect of the present disclosure, an apparatus for managing code data is provided. The apparatus comprises: a determining module configured to determine an application programming interface associated with a merge request in response to receiving the merge request for merging first code data into second code data; an obtaining module configured to obtain an interface definition of the application programming interface, the interface definition describing at least one data item specified in the application programming interface; an adding module configured to add annotation data associated with the at least one data item to the interface definition, the annotation data describing the at least one data item in accordance with a code specification of a code management platform; and a committing module configured to commit the second code data to the code management platform based on the interface definition.

In a third aspect of the present disclosure, an electronic device is provided. The electronic device comprises at least one processor; and at least one memory coupled to the at least one processor and stores instructions for execution by the at least one processor, the instructions, when executed by the at least one processor, cause the electronic device to perform the method according to the first aspect of the present disclosure.

In a fourth aspect of the present disclosure, there is provided a computer-readable storage medium having stored thereon a computer program which, when executed by a processor, causes the processor to perform the method according to the first aspect of the present disclosure.

In a fifth aspect of the present disclosure, there is provided a computer program product comprising a computer program, wherein the computer program, when executed by a processor, performs the method according to the first aspect of the present disclosure.

It should be understood that the content described in this disclosure is not intended to limit key features or important features of implementations of the present disclosure, nor is it intended to limit the scope of the present disclosure. Other features of the present disclosure will become readily understood from the following description.

### BRIEF DESCRIPTION OF DRAWINGS

The above and other features, advantages, and aspects of the various implementations of the present disclosure will become more apparent from the following detailed description taken in combination with the accompanying drawings. In the drawings, the same or similar reference numbers refer to the same or similar elements, wherein:

FIG. 1 illustrates a block diagram of an application environment according to an implementation of the present disclosure;

FIG. 2 illustrates a block diagram for managing code data according to some implementations of the present disclosure;

FIG. 3 illustrates a block diagram for committing code data to a code management platform according to some implementations of the present disclosure;

FIG. 4 illustrates a block diagram of an interface definition according to some implementations of the present disclosure;

FIG. 5 illustrates a block diagram of specifying attributes of data items in a code management platform according to some implementations of the present disclosure;

FIG. 6 illustrates a flowchart of a method for managing code data according to some implementations of the present disclosure;

FIG. 7 illustrates a block diagram of an apparatus for managing code data according to some implementations of the present disclosure; and

FIG. 8 illustrates a block diagram of a device capable of implementing various implementations of the present disclosure.

### DETAILED DESCRIPTION

Implementations of the present disclosure will be described in more detail below with reference to the accompanying drawings. While certain implementations of the present disclosure are shown in the accompanying drawings, it should be understood that the present disclosure may be implemented in various forms and should not be construed as limited to the implementations set forth herein, but rather, these implementations are provided for a more thorough and complete understanding of the present disclosure. It should be understood that the drawings and implementations of the present disclosure are for illustrative purposes only and are not intended to limit the scope of the present disclosure.

In the description of implementations of the present disclosure, the terms “include/comprise” and similar terms should be understood to include “including/comprising but not limited to”. The term “based on” should be understood as “based at least in part on”. The terms “an implementation”, “one implementation”, or “the implementation” should be understood as “at least one implementation”. The term “some implementations” should be understood as “at least some implementations”. Other explicit and implicit definitions may also be included below. As used herein, the term “model” may represent an association between various data. For example, the association may be obtained based on various technical solutions currently known and/or to be developed in the future.

It may be understood that the data involved in the technical solution (including but not limited to the data itself, the acquisition or use of the data) should follow the requirements of the corresponding laws and regulations, and related provisions.

It can be understood that, before the technical solutions disclosed in the embodiments of the present disclosure are used, the types of personal information, the usage scope, the usage scenario and the like related to the present disclosure should be notified to the user in an appropriate manner according to the relevant laws and regulations, and the authorization of the user is obtained.

For example, in response to receiving an active request from a user, prompt information is sent to the user to explicitly prompt the user that the requested operation will need to acquire and use the personal information of the user. Therefore, the user can autonomously select whether to provide personal information to software or hardware executing the operation of the technical solution of the present disclosure according to the prompt information.

As an optional but non-limiting implementation, in response to receiving an active request from the user, sending prompt information to the user may be, for example, in the form of a pop-up window, and prompt information may be presented in a text manner in the pop-up window. In addition, the pop-up window may further carry a selection control for the user to select “agree” or “disagree” to provide personal information to the electronic device.

It may be understood that the foregoing processes of notification and obtaining a user authorization are merely illustrative, and do not constitute a limitation on implementations of the present disclosure, and other manners of meeting related laws and regulations may also be applied to implementations of the present disclosure.

The term “in response to” as used herein means a state in which a respective event occurs or a condition is satisfied. It will be appreciated that the timing of execution of a subsequent action performed in response to the event or condition is not necessarily strongly correlated with the time at which the event occurs or the condition holds. For example, in some cases, the subsequent action may be performed immediately when an event occurs or a condition holds; while in other cases, the subsequent action may be performed after a period of time elapses after an event occurs or a condition holds.

### Example Environment

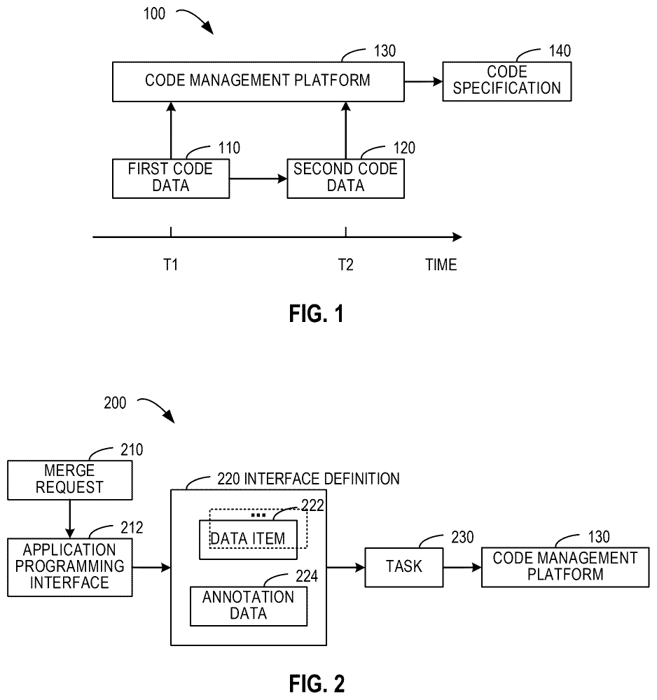

The process of software development needs to follow various specifications, and as the scale of the application is continuously enlarged, the code specifications involved become increasingly numerous. For example, during application development, developers may constantly complete the functions of an application. The developers may commit the code data of the application to a unified code management platform to check whether the code data conforms to a predetermined code specification. Referring to FIG. 1, which demonstrates an application environment according to some implementations of the present disclosure, FIG. 1 illustrates a block diagram 100 of the application environment according to an implementation of the present disclosure. As shown in FIG. 1, in a process of application development, code data in different versions may exist at different time points. For example, there may be first code data 110 at time point T1 and second code data 120 at time point T2. At time point T1, the developers may commit the first code data 110 to a code management platform 130. To facilitate the management of the code data, the code management platform requires the committer to interpret the meaning of respective data items in the code data according to the format specified by the platform, for example, determine that a data item corresponds to a certain attribute in the code specification.

Generally, the developers may declare basic information of respective data items of the first code data 110 in an interface definition (for example, written by using an Interface Definition Language), and import the interface definition into the code management platform. Further, the meaning of respective data items of the code data may be filled in one by one in the interface provided by the code platform. However, this leads to a large number of manual operations, especially the process of application development may involve multiple versions, at which time respective data items of the code data need to be manually processed.

As the development process proceeds, there may be the second code data 120 at time point T2, and the developers need to commit the second code data 120 to the code management platform 130. At this time, the developers have to fill in the meaning of the respective data items of the second code data 120 one by one again. The above process needs to switch between multiple interfaces of the software development platform and the code management platform, and the operation is complex and prone to errors. Further, the manual annotation process may result in omissions, which may lead to a failure to verify whether there is a risk in the code data in the code management platform, thereby preventing the normal use of the code data. At this point, it is desirable to manage code data in a more efficient and reliable manner.

### Summary of Managing Code Data

In order to at least partially remove the drawbacks in the prior art, a method for managing code data is proposed according to an implementation of the present disclosure. Referring to FIG. 2, a summary is described according to an implementation of the present disclosure, and FIG. 2 illustrates a block diagram 200 for managing code data according to some implementations of the present disclosure. As shown in FIG. 2, a method for managing code data is proposed. Specifically, a merge request 210 for merging the first code data into the second code data may be received, and an application programming interface (API) 212 associated with the merge request is determined. Further, an interface definition 220 of the API 212 may be obtained. Here, the interface definition 220 may describe at least one data item 222 (for example, a field defined in the code data) specified in the API 212.

Annotation data 224 associated with at least one data item may be added to the interface definition 220, the annotation data 224 describes at least one data item in accordance with a code specification of a code management platform. For example, the annotation data may specify a label for the data item that maps the data item to an attribute specified in the code specification of the code management platform. At this time, the second code data may be committed to the code management platform 130 based on the interface definition 220. In turn, in the code management platform 130, at least one data item may be described in accordance with the code specification based on the annotation data. In this way, the meaning of the data item may be automatically described in the code management platform, the workload of manual annotation may be reduced, and the potential risk that the code data cannot be used due to human errors may be avoided.

### Detailed Process of Managing Code Data

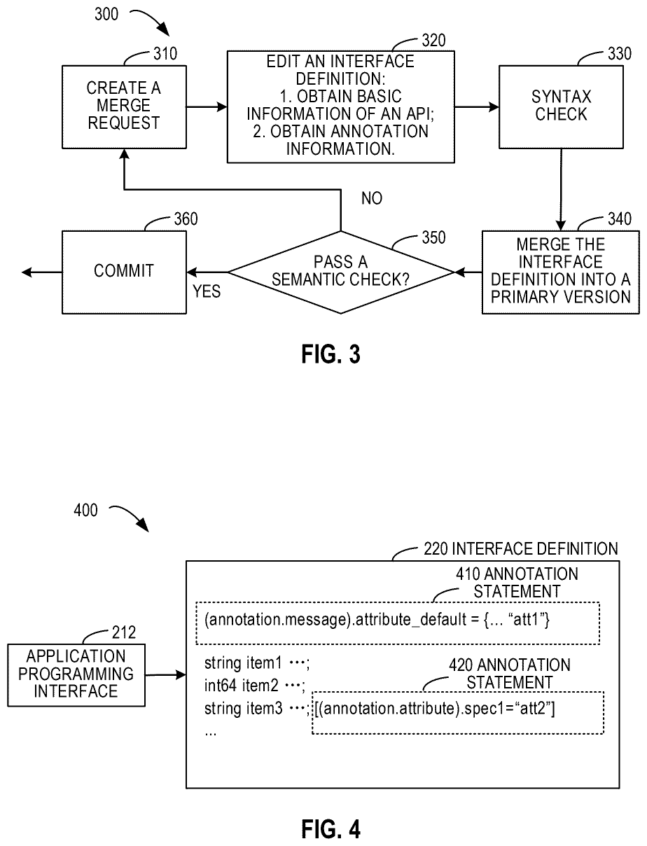

Having described a summary according to some implementations of the present disclosure, more details regarding the method for managing code data will be described below. Further details regarding code data management are described with reference to FIG. 3, which illustrates a block diagram 300 for committing code data to a code management platform according to some implementations of the present disclosure. As shown in FIG. 3, at block 310, a merge request may be created, which may represent the merging of the second code data from a subsequent time point T2 into the first code data from a previous time point T1.

At block 320, an interface definition associated with the merge request may be edited. According to some implementations of the present disclosure, an application programming interface associated with the merge request may first be determined. In this process, difference data between the first code data and the second code data may be determined; and the application programming interface is determined based on the difference data. Specifically, the first code data is a version at the time point T1, and the second code data is a version at the time point T2, and the first code data and the second code data may be compared to determine the difference data.

It should be understood that the difference data may involve a variety of situations. Assuming that the first code data includes API1, API2, and API3, the second code data may include API3, new API4, updated API1 (for example, denoted as API1′), and not include API2 (that is, API2 is deleted). At this time, a corresponding application programming interface may be determined based on the difference. In this case, since the API3 in the second code data does not change, the interface definition of the API3 when the first code data is last committed may be reused. Since the second code data does not include API2, API2 may no longer be considered during this commit, and at this time, annotation data may be added to only interface definitions of API4 and API1′.

It should be understood that only an example of the interface definition is shown above; alternatively, and/or in addition, the interface definition may involve more, fewer, or different APIs. With some implementations of the present disclosure, only different parts of the software development process need to be processed, and only annotation data associated with the different parts needs to be added. In this way, the amount of data to be processed may be reduced, thereby reducing the workload related to code data management.

At block 320, basic information of an API associated with the difference data may be obtained, for example, names, types, and the like of respective data items defined in the API may be obtained. Then, annotation data of respective data items may be obtained. According to some implementations of the present disclosure, the annotation data is configured to map the at least one data item specified in the application programming interface to at least one attribute specified in the code specification. It should be understood that the code specification may specify various attributes of the data item in the code data. For example, a classification of the data item may be specified, whether the data item is in a hidden state may be specified (for example, the data item may be hidden automatically when the data item is not allowed to be used), or the like. Assuming that the code specification defines the following attributes: att1, att2, . . . , attn, then the annotation data may be used to map the data item to a specific attribute. For example, in a process in which a user inputs the annotation data according to an annotation format, candidate items corresponding to the attributes att1, att2, . . . , attn may be automatically provided, to support the user to directly select a desired attribute. In this way, the annotation data may be added to the interface definition in an automated manner, thereby automatically generating tasks to be performed in the code management platform.

According to some implementations of the present disclosure, in a process of adding the annotation data to the interface definition, an annotation format corresponding to the code specification may be provided, and the annotation data, input in accordance with the annotation format, corresponding to the at least one data item may be received. For example, an attribute corresponding to the current data item may be selected among a plurality of pop-up candidates. Assuming that the code data includes data item item1, and the data item belongs to attribute att1, at this time, the attribute att1 may be selected for the data item item1. Further, the annotation data may be added at a location, in the interface definition, corresponding to the at least one data item. For example, the annotation data may be added after the basic information of the data item item1. With some implementations of the present disclosure, the annotation format may map the data item to the attribute corresponding to the code specification; in this way, the user may be facilitated to specify a corresponding attribute for the data item in the code data.

According to some implementations of the present disclosure, the annotation data may include multiple types. For example, the annotation data may include an annotation statement mapping the at least one data item to a default attribute of the at least one attribute. In this way, the default attribute may be automatically specified for respective data items in the code data, for example, the aforementioned annotation statement may be added at the start location of the interface definition. Referring to FIG. 4 for more details, FIG. 4 illustrates a block diagram 400 of an interface definition according to some implementations of the present disclosure. As shown in FIG. 4, a plurality of data items may be defined in the API 212. The basic information of respective data items is shown in the interface definition 220, where: the type of the data item item1 is a string type, the type of the data item item 2 is a 64-bit integer (int 64), and the type of the data item item 3 is the string type. Alternatively, and/or in addition, the API 212 may include more, fewer, or different data items.

An annotation statement 410 may automatically specify the default attribute for the respective data items in the code data, specifically, the annotation statement 410 may map the data items item1, item2,···, item3, and so on to the default attribute “att1”. In this way, attributes of a plurality of data items may be specified by an annotation statement in a simple and efficient manner, thereby avoiding complex operations of specifying attributes separately for each data item. Alternatively, and/or in addition, the annotation statement may map the at least one data item to a target attribute of the at least one attribute. For example, an annotation statement 420 may map data item item3 to attribute “att2”. In this way, a desired attribute is allowed to be specified for a single data item, thereby supporting managing respective data items in the code data in a more flexible manner.

According to some implementations of the present disclosure, the annotation data may support a plurality of code specifications. For example, suppose an application is to be published in different regions, and different regions may have respective code specifications. In this case, an identifier of the code specification followed by the code statement may be specified in the code statement. For example, keyword “spec1” in the annotation statement 420 may specify that the statement maps the data item item3 to the attribute “att2” in the code specification of the identifier “spec1”. In this way, the annotation format may simultaneously support multiple different code specifications, thereby managing code data of applications to be published in different regions in a more convenient and efficient manner.

Returning to FIG. 3, at block 330, a syntax check may be performed for the interface definition 220 shown in FIG. 4. Whether the respective statements in the interface definition 220 comply with a syntax requirement may be checked. It should be understood that since the interface definition 220 includes basic information and annotation data of the API, the syntax check herein may include two aspects: checking whether the basic information part conforms to the syntax of the interface definition language, and checking whether the annotation data conforms to the syntax of the annotation format.

According to some implementations of the present disclosure, a syntax check may be performed for the interface definition. Prompt information for re-editing the interface definition may be provided in response to determining that the interface definition fails the syntax check. Specifically, whether identifiers, types, and the like of respective data items in the interface definition are consistent with the definition in the API may be determined first, and whether the annotation data conforms to the syntax of the annotation format may be further determined. For example, whether the keywords in the annotation statements 410 and 420 in FIG. 4 are keywords supported by the annotation format may be determined respectively, whether the identifier of the code specification in the annotation statement is correct may be determined, and so on. With some implementations of the present disclosure, the accuracy of the syntax of the interface definition may be ensured, thereby avoiding an exception in the process of subsequently committing the code data to the code management platform.

According to some implementations of the present disclosure, as shown in FIG. 3, if the interface definition fails the syntax check, then return to block 320, the interface definition may be re-edited. In response to determining that the interface definition passes the syntax check, at block 340, the interface definition may be merged into the interface definition of a primary version. Here, the primary version may represent a previous version committed to the code management platform, such as the response interface definition of the first code data described above. In this case, the merged interface definition may include data items defined in all code data and corresponding annotation data.

According to some implementations of the present disclosure, a semantic check may be performed for the interface definition, and prompt information for re-editing the merge request is provided in response to determining that the interface definition fails the semantic check. At block 350, a semantic check may be performed for the merged interface definition. This semantic check can be used to determine whether the annotation data in the interface definition can clearly describe the respective data items in the interface definition in accordance with the code specification of the code management platform.

Specifically, it may be checked whether a certain data item is omitted in the interface definition, whether the label of the attribute specified for the data item is the label defined in the code specification, whether all information required in the code specification has been filled for the data item, and so on. If the interface definition successfully passes the semantic check, the operational flow may proceed to block 360 to commit the code data to the code management platform. Alternatively, and/or in addition, if the interface definition fails the semantic check, the operational flow may return to block 310 to modify the merge request. With some implementations of the present disclosure, it can be ensured that the interface definition already includes all the correct information required by the code management platform, thereby avoiding the potential risk of needing to recommit the code data due to the lack of certain information, or committing erroneous information.

According to some implementations of the present disclosure, in the process of committing the second code data to the code management platform based on the interface definition, a commit request for committing the second code data to the code management platform and mapping, in the code management platform, the at least one data item to the at least one attribute may be generated based on the annotation data. Specifically, the commit request may commit the second code data in a format specified by the code management platform. Further, the commit request may further include an instruction supported by the code management platform, and after receiving the instruction, the code management platform may automatically invoke the instruction to map, in the code management platform, the at least one data item to the at least one attribute. Here, the instruction may be generated according to the work order format of the code management platform.

According to some implementations of the present disclosure, in the process of generating the commit request based on the annotation data, the at least one attribute corresponding to the at least one data item may be extracted from the annotation data in the interface definition; and the commit task is generated in accordance with a task definition standard of the code management platform. The commit task may include one or more instructions, for example, the default attribute “att1” corresponding to the respective data items may be extracted from the annotation statement 410, in this case, “attribute” represents the name of the attribute, and “att1” represents the value of the default attribute, in this case, the instruction may be generated in accordance with the task definition standard of the code platform, for example, an example of the instruction is: all attribute=att1. Alternatively, and/or in addition, the attribute “att2” corresponding to the data item item3 may be extracted from the annotation statement 420, and in this case an example of the instruction is: item3. attribute=att2.

It should be understood that the instructions in the above commit tasks are merely exemplary, alternatively, and/or in addition, more, fewer, or different instructions may be generated based on the annotation data. Alternatively, and/or in addition, the formats of the instructions described above are also illustrative, and instructions having different formats are generated based on the task definition annotations of the code management platform.

Further, the commit request may be sent to the code management platform. At this time, the commit request may trigger one or more instructions to map the data items to corresponding attributes in the code management platform. With some implementations of the present disclosure, the commit request may be automatically generated, and after receiving the commit request, the code management platform may directly invoke various instructions in the commit request, and further map the at least one data item to the at least one attribute in the code management platform.

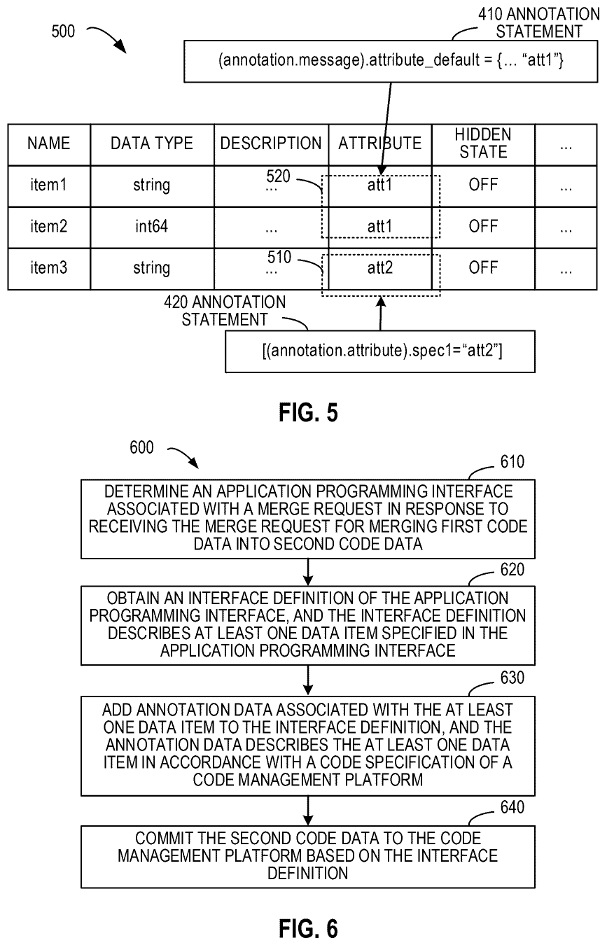

Further details are described with reference to FIG. 5, which illustrates a block diagram 500 of specifying attributes of data items in a code management platform according to some implementations of the present disclosure. As shown in FIG. 5, the basic information (for example, the name, type, description, and so on) of the data items in the code data is imported to the code management platform. Further, the commit task may be automatically performed in the code management platform to specify attributes for the respective data items. For example, an instruction generated based on the annotation statement 410 is invoked in the code management platform, and attributes of item1 and item2 may be respectively specified as “att1”; an instruction generated based on the annotation statement 420 is invoked in the code management platform, and the attribute of item3 may be specified as “att2”, and so on. Alternatively, and/or in addition, instructions for specifying other attributes (for example, a hidden state, and so on) may be generated in a similar manner. With some implementations of the present disclosure, there is no need for a user to specify a specific value of an attribute for each data item one by one in the code management platform.

With implementations of the present disclosure, in the code management platform, at least one data item may be automatically described in accordance with the annotation data. In this way, the workload of manual processing may be reduced, and the potential risk that the code data cannot be used due to human error may be avoided.

### Example Process

FIG. 6 illustrates a flowchart of a method 600 for managing code data according to some implementations of the present disclosure. At block 610, an application programming interface associated with a merge request is determined in response to receiving the merge request for merging first code data into second code data. At block 620, an interface definition of the application programming interface is obtained, and the interface definition describes at least one data item specified in the application programming interface. At block 630, annotation data associated with the at least one data item is added to the interface definition, and the annotation data describes the at least one data item in accordance with a code specification of a code management platform. At block 640, the second code data is committed to the code management platform based on the interface definition.

According to some implementations of the present disclosure, determining the application programming interface associated with the merge request comprises: determining difference data between the first code data and the second code data; and determining the application programming interface based on the difference data.

According to some implementations of the present disclosure, adding the annotation data to the interface definition comprises: providing an annotation format corresponding to the code specification; receiving the annotation data, input in accordance with the annotation format, corresponding to the at least one data item; and adding the annotation data at a location, in the interface definition, corresponding to the at least one data item.

According to some implementations of the present disclosure, the annotation data is configured map the at least one data item specified in the application programming interface to at least one attribute specified in the code specification.

According to some implementations of the present disclosure, the annotation data comprises at least one of: an annotation statement mapping the at least one data item to a default attribute of the at least one attribute; or an annotation statement mapping the at least one data item to a target attribute of the at least one attribute.

According to some implementations of the present disclosure, the method further comprises: performing a syntax check for the interface definition; and providing prompt information for re-editing the interface definition in response to determining that the interface definition fails the syntax check.

According to some implementations of the present disclosure, the method further comprises: performing a semantic check for the interface definition; and providing prompt information for re-editing the merge request in response to determining that the interface definition fails the semantic check.

According to some implementations of the present disclosure, committing the second code data to the code management platform based on the interface definition comprises: generating, based on the annotation data, a commit request for committing the second code data to the code management platform and mapping, in the code management platform, the at least one data item to the at least one attribute; and sending the commit request to the code management platform.

According to some implementations of the present disclosure, generating the commit request based on the annotation data comprises: extracting the at least one attribute corresponding to the at least one data item from the annotation data in the interface definition; and generating the commit task in accordance with a task definition standard of the code management platform.

### Example Apparatus and Device

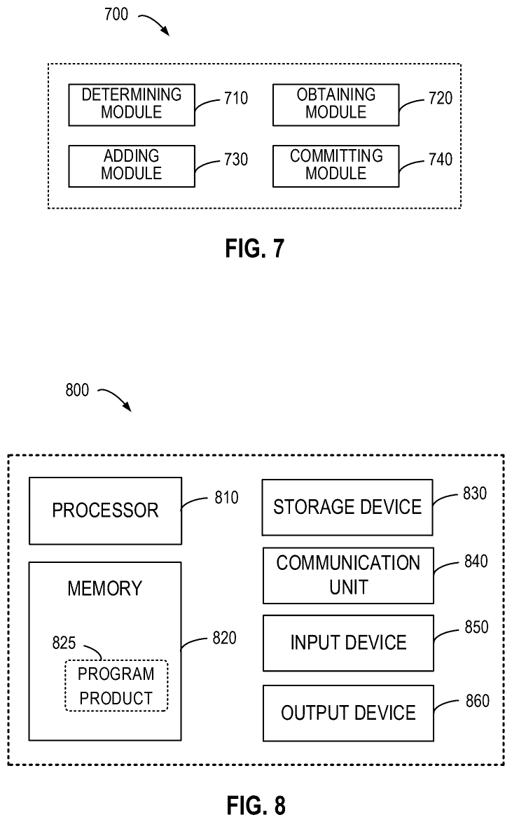

FIG. 7 illustrates a block diagram of an apparatus 700 for managing code data according to some implementations of the present disclosure. The apparatus 700 comprises: a determining module 710 configured to determine an application programming interface associated with a merge request in response to receiving the merge request for merging first code data into second code data; an obtaining module 720 configured to obtain an interface definition of the application programming interface, the interface definition describing at least one data item specified in the application programming interface; an adding module 730 configured to add annotation data associated with the at least one data item to the interface definition, the annotation data describing the at least one data item in accordance with a code specification of a code management platform; and a committing module 740 configured to commit the second code data to the code management platform based on the interface definition.

According to some implementations of the present disclosure, the determining module is further configured to determine difference data between the first code data and the second code data; and determine the application programming interface based on the difference data.

According to some implementations of the present disclosure, the adding module is further configured to provide an annotation format corresponding to the code specification; receive the annotation data, input in accordance with the annotation format, corresponding to the at least one data item; and add the annotation data at a location, in the interface definition, corresponding to the at least one data item.

According to some implementations of the present disclosure, the annotation data is configured map the at least one data item specified in the application programming interface to at least one attribute specified in the code specification.

According to some implementations of the present disclosure, the annotation data comprises at least one of: an annotation statement mapping the at least one data item to a default attribute of the at least one attribute; or an annotation statement mapping the at least one data item to a target attribute of the at least one attribute.

According to some implementations of the present disclosure, the apparatus further comprises processing module configured to perform a syntax check for the interface definition; and provide prompt information for re-editing the interface definition in response to determining that the interface definition fails the syntax check.

According to some implementations of the present disclosure, the apparatus further comprises processing module configured to perform a semantic check for the interface definition; and provide prompt information for re-editing the merge request in response to determining that the interface definition fails the semantic check.

According to some implementations of the present disclosure, the committing module is further configured to generate, based on the annotation data, a commit request for committing the second code data to the code management platform and mapping, in the code management platform, the at least one data item to the at least one attribute; and send the commit request to the code management platform.

According to some implementations of the present disclosure, the committing module is further configured to extract the at least one attribute corresponding to the at least one data item from the annotation data in the interface definition; and generate the commit task in accordance with a task definition standard of the code management platform.

FIG. 8 illustrates a block diagram of a device 800 capable of implementing various implementations of the present disclosure. It should be understood that the computing device 800 shown in FIG. 8 is merely exemplary and should not constitute any limitation on the functionality and scope of the implementations described herein. The computing device 800 shown in FIG. 8 may be configured to implement the method described above.

As shown in FIG. 8, the computing device 800 is in the form of a general-purpose computing device. Components of the computing device 800 may include, but are not limited to, one or more processing units or processors 810, a memory 820, a storage device 830, one or more communication units 840, one or more input devices 850, and one or more output devices 860. The processor 810 may be an actual or virtual processor and capable of performing various processes according to programs stored in the memory 820. In multiprocessor systems, multiple processors execute computer-executable instructions in parallel to improve the parallel processing capabilities of the computing device 800.

The computing device 800 typically includes a plurality of computer storage media. Such medi may be any available medium accessible by the computing device 800, including, but not limited to, a volatile and non-volatile medium, a removable and non-removable medium. The memory 820 may be a volatile memory (for example, a register, a cache, a random access memory (RAM)), a non-volatile memory (for example, a read-only memory (ROM), an electrically erasable programmable read-only memory (EEPROM), a flash memory), or some combination thereof. The storage device 830 may be a removable or non-removable medium and may include a machine-readable medium, such as a flash drive, a magnetic disk, or any other medium, which may be capable of storing information and/or data (for example, training data for training) and may be accessed within the computing device 800.

The computing device 800 may further include an additional removable/non-removable, volatile/non-volatile storage medium. Although not shown in FIG. 8, a disk drive for reading or writing from a removable, non-volatile magnetic disk (for example, a “floppy disk”) and an optical disk drive for reading or writing from a removable, non-volatile optical disk may be provided. In these cases, each drive may be connected to a bus (not shown) by one or more data medium interfaces. The memory 820 may include a computer program product 825 having one or more program modules configured to perform various methods or actions according to various implementations of the present disclosure.

The communications unit 840 implements communications with other computing devices over a communication medium. In addition, the functionality of components of the computing device 800 may be implemented in a single computing cluster or multiple computing machines capable of communicating over a communication connection. Thus, the computing device 800 may operate in a networked environment using logical connections with one or more other servers, network personal computers (PCs), or another network node.

The input device 850 may be one or more input devices such as a mouse, a keyboard, a trackball, or the like. The output device 860 may be one or more output devices, such as a display, a speaker, a printer, or the like. The computing device 800 may also communicate with one or more external devices (not shown) as needed, external devices such as storage devices, display devices, and so on, communicate with one or more devices that enable a user to interact with the computing device 800, or communicate with any device (for example, a network card, a modem, and so on) that enables the computing device 800 to communicate with one or more other computing devices. Such communication may be performed via an input/output (I/O) interface (not shown).

According to an implementation of the present disclosure, there is provided a computer-readable storage medium having stored thereon computer-executable instructions, where the computer-executable instructions are executed by a processor to implement the method described above. According to an implementation of the present disclosure, a computer program product is further provided, the computer program product being tangibly stored on a non-transitory computer-readable medium and including computer-executable instructions, and the computer-executable instructions being executed by a processor to perform the method described above. According to an implementation of the present disclosure, there is provided a computer program product having stored thereon a computer program which, when executed by a processor, performs the foregoing method.

Aspects of the present disclosure are described herein with reference to flowcharts and/or block diagrams of methods, apparatuses, devices, and computer program products implemented in accordance with the present disclosure. It should be understood that each block of the flowchart and/or block diagram, and combinations of blocks in the flowcharts and/or block diagrams, may be implemented by computer-readable program instructions.

These computer-readable program instructions may be provided to a processing unit of a general-purpose computer, special-purpose computer, or other programmable data processing device to produce a machine, such that the instructions, when executed by a processing unit of a computer or other programmable data processing device, produce means to implement the functions/acts specified in the flowchart and/or block diagram. These computer-readable program instructions may also be stored in a computer-readable storage medium that cause the computer, programmable data processing device, and/or other devices to function in a particular manner, such that the computer-readable medium storing instructions includes an article of manufacture including instructions to implement aspects of the functions/acts specified in the one or more blocks of the flowcharts and/or block diagrams.

The computer-readable program instructions may be loaded onto a computer, other programmable data processing device, or other devices, such that a series of operational steps are performed on a computer, other programmable data processing device, or other devices to produce a computer-implemented process such that the instructions executed on a computer, other programmable data processing devices, or other devices implement the functions/acts specified in one or more blocks of the flowcharts and/or block diagrams.

The flowcharts and block diagrams in the figures show the architecture, functionality, and operation of possible implementations of systems, methods, and computer program products according to various implementations of the present disclosure. In this regard, each block in the flowcharts or block diagrams may represent a portion of a module, a program segment, or an instruction that includes one or more executable instructions for implementing the specified logical function. In some alternative implementations, the functions noted in the blocks may also occur in a different order than noted in the figures. For example, two consecutive blocks may actually be performed substantially in parallel, which may sometimes be performed in the reverse order, depending on the functionality involved. It is also noted that each block of the block diagrams and/or flowcharts, as well as combinations of blocks in the block diagrams and/or flowcharts, may be implemented with a dedicated hardware-based system that performs the specified functions or actions, or may be implemented in a combination of dedicated hardware and computer instructions.

Various implementations of the present disclosure have been described above, which are exemplary, not exhaustive, and are not limited to the implementations disclosed. Many modifications and variations will be apparent to those of ordinary skill in the art without departing from the scope and spirit of the various implementations illustrated. The selection of the terms used herein is intended to best explain the principles of the implementations, practical applications, or improvements to techniques in the marketplace, or to enable others of ordinary skill in the art to understand the various implementations disclosed herein.

What is claimed is:

1. A method for managing code data, comprising:
determining an application programming interface associated with a merge request in response to receiving the merge request for merging first code data into second code data;
obtaining an interface definition of the application programming interface, the interface definition describing at least one data item specified in the application programming interface;
adding annotation data associated with the at least one data item to the interface definition, the annotation data describing the at least one data item in accordance with a code specification of a code management platform; and
committing the second code data to the code management platform based on the interface definition.

2. The method of claim 1, wherein determining the application programming interface associated with the merge request comprises:
determining difference data between the first code data and the second code data; and
determining the application programming interface based on the difference data.

3. The method of claim 1, wherein adding the annotation data to the interface definition comprises:
providing an annotation format corresponding to the code specification;
receiving the annotation data, input in accordance with the annotation format, corresponding to the at least one data item; and
adding the annotation data at a location, in the interface definition, corresponding to the at least one data item.

4. The method of claim 3, wherein the annotation data is configured to map the at least one data item specified in the application programming interface to at least one attribute specified in the code specification.

5. The method of claim 4, wherein the annotation data comprises at least one of:
an annotation statement mapping the at least one data item to a default attribute of the at least one attribute; or
an annotation statement mapping the at least one data item to a target attribute of the at least one attribute.

6. The method of claim 1, further comprising:
performing a syntax check for the interface definition; and
providing prompt information for re-editing the interface definition in response to determining that the interface definition fails the syntax check.

7. The method of claim 1, further comprising:
performing a semantic check for the interface definition; and
providing prompt information for re-editing the merge request in response to determining that the interface definition fails the semantic check.

8. The method of claim 4, wherein committing the second code data to the code management platform based on the interface definition comprises:
generating, based on the annotation data, a commit request for committing the second code data to the code management platform and mapping, in the code management platform, the at least one data item to the at least one attribute; and
sending the commit request to the code management platform.

9. The method of claim 8, wherein generating the commit request based on the annotation data comprises:
extracting the at least one attribute corresponding to the at least one data item from the annotation data in the interface definition; and
generating a commit task in accordance with a task definition standard of the code management platform.

10. An electronic device, comprising:
at least one processor; and
at least one memory coupled to the at least one processor and storing instructions for execution by the at least one processor, the instructions, when executed by the at least one processor, causing the electronic device to perform operations comprising:
determining an application programming interface associated with a merge request in response to receiving the merge request for merging first code data into second code data;
obtaining an interface definition of the application programming interface, the interface definition describing at least one data item specified in the application programming interface;
adding annotation data associated with the at least one data item to the interface definition, the annotation data describing the at least one data item in accordance with a code specification of a code management platform; and
committing the second code data to the code management platform based on the interface definition.

11. The electronic device of claim 10, wherein determining the application programming interface associated with the merge request comprises:
determining difference data between the first code data and the second code data; and
determining the application programming interface based on the difference data.

12. The electronic device of claim 10, wherein adding the annotation data to the interface definition comprises:
providing an annotation format corresponding to the code specification;
receiving the annotation data, input in accordance with the annotation format, corresponding to the at least one data item; and
adding the annotation data at a location, in the interface definition, corresponding to the at least one data item.

13. The electronic device of claim 12, wherein the annotation data is configured to map the at least one data item specified in the application programming interface to at least one attribute specified in the code specification.

14. The electronic device of claim 13, wherein the annotation data comprises at least one of:
an annotation statement mapping the at least one data item to a default attribute of the at least one attribute; or
an annotation statement mapping the at least one data item to a target attribute of the at least one attribute.

15. The electronic device of claim 10, the operations further comprising:
performing a syntax check for the interface definition; and
providing prompt information for re-editing the interface definition in response to determining that the interface definition fails the syntax check.

16. The electronic device of claim 10, the operations further comprising:
performing a semantic check for the interface definition; and
providing prompt information for re-editing the merge request in response to determining that the interface definition fails the semantic check.

17. The electronic device of claim 13, wherein committing the second code data to the code management platform based on the interface definition comprises:
generating, based on the annotation data, a commit request for committing the second code data to the code management platform and mapping, in the code management platform, the at least one data item to the at least one attribute; and
sending the commit request to the code management platform.

18. The electronic device of claim 17, wherein generating the commit request based on the annotation data comprises:
extracting the at least one attribute corresponding to the at least one data item from the annotation data in the interface definition; and
generating a commit task in accordance with a task definition standard of the code management platform.

19. A non-transitory computer-readable storage medium having stored thereon computer instructions which, when executed by a processor, cause the processor to perform operations comprising:
determining an application programming interface associated with a merge request in response to receiving the merge request for merging first code data into second code data;
obtaining an interface definition of the application programming interface, the interface definition describing at least one data item specified in the application programming interface;
adding annotation data associated with the at least one data item to the interface definition, the annotation data describing the at least one data item in accordance with a code specification of a code management platform; and
committing the second code data to the code management platform based on the interface definition.

20. The non-transitory computer-readable storage medium of claim 19, wherein determining the application programming interface associated with the merge request comprises:
determining difference data between the first code data and the second code data; and
determining the application programming interface based on the difference data.
